(19) United States
(12) Patent Application Publication
(10) Pub. No.: US 2010/0170081 A1
(43) Pub. Date: Jul. 8, 2010

(54) CLAMP DEVICE

(76) Inventors: Takayuki Kuroda, Hyogo (JP); Yuko Kamata, Aichi (JP)

Correspondence Address: BIRCH STEWART KOLASCH & BIRCH, PO BOX 747, FALLS CHURCH, VA, 22040-0747, US

(21) Appl. No.: 12/376,916

(22) PCT Filed: Aug. 9, 2007
(86) PCT No.: PCT/JP2007/065596

§ 371 Date: Feb. 9, 2009

(30) Foreign Application Priority Data
Aug. 10, 2006 (JP) 2006-218704

(51) Int. Cl. B23Q 7/00; B25B 1/06

(52) U.S. Cl. 29/559; 269/216

(57) ABSTRACT

A clamp device includes a first clamp head movable but restricted in movement in a perpendicular direction that is at right angles to a travel direction, and serving as a reference side, a second clamp head movable in a direction coming closer to and in a direction farther away from the first clamp head, capable of clamping a workpiece located between the first and second clamp heads, and tiltable and/or slidable in the perpendicular direction, and a drive unit driving the first and second clamp heads. The workpiece is clamped with the first and second clamp heads by moving the first and second clamp heads in a direction coming closer to each other.

### TECHNICAL FIELD

The present invention relates to clamp devices, particularly a clamp device that can clamp a workpiece from both sides.

### BACKGROUND ART

There is conventionally known a device that can carry a workpiece in a clamped state and/or that works on a workpiece in a clamped state. For example, Japanese Patent Publication No. 1-16598 discloses a work clamp device for a frictional press-welding machine. Japanese Patent Laying-Open No. 6-31564 discloses a clamp device employed in an end-finishing machine, Japanese Patent Laying-Open No. 8-39386 discloses a gantry loader for holding and carrying a workpiece on a lathe.
Patent Document 1: Japanese Patent Publication No. 1-16598
Patent Document 2: Japanese Patent Laying-Open No. 6-31564
Patent Document 3: Japanese Patent Laying-Open No. 8-39386

### DISCLOSURE OF THE INVENTION

### Problems To Be Solved By the Invention

In the work clamp device disclosed in the aforementioned Japanese Patent

Publication No. 1-16598, two opposable sliders 68 and 70 are disposed in a slidable manner on a head 66. Claws 72 and 74 are attached to each opposable face of sliders 68 and 70. A workpiece 102 is clamped by compressing workpiece 102 with one claw 72 while the other claw 74 is arrested at a centering point. However, the work clamp device disclosed in the aforementioned Japanese

Patent Publication No. 1-16598 cannot have both claws 72 and 74 moved in a tiltable manner. A gap will be produced between workpiece 102 and claws 72, 74 in the clamping operation of workpiece 102, so that the contact area of claws 72 and 74 with respect to workpiece 102 may be reduced. There is a problem that workpiece 102 cannot be clamped stably by claws 72 and 74 in such an event.

The clamp device disclosed in the aforementioned Japanese Patent Laying-Open No. 6-31564 includes clamp claws 13c and 14c, which are driven to clamp a rod steel member W. Since both clamp claws 13c and 14c cannot move in a tiltable manner in this device, there is a problem that rod steel member W cannot be clamped stably by clamp claws 13c and 14c, likewise with the aforementioned work clamp device.

The gantry loader disclosed in Japanese Patent Laying-Open No. 8-39386 includes a loader claw 9 that is slidable with respect to a head arm 8. Loader claw 9 slides in the gripping operation of a workpiece. Therefore, an area of contact between loader claw 9 and the workpiece can be ensured, as compared to that of the aforementioned workpiece device.

However, the gantry loader disclosed in Japanese Patent Laying-Open No. 8-39386 is disadvantageous in that the workpiece may be clamped at a site deviated from a predetermined site since loader claws 9 both swing during the clamping operation of a workpiece. Namely, there is a problem that the clamping position of the workpiece is degraded in accuracy.

In view of the foregoing, an object of the present invention is to provide a clamp device that can clamp a workpiece stably while avoiding degradation in the accuracy of the clamping position of the workpiece.

### Means For Solving the Problems

According to an aspect of the present invention, a clamp device of the present invention includes a first clamp head movable but restricted in movement in a perpendicular direction that is at right angles to a travel direction, and serving as a reference side; a second clamp head movable in a direction coming closer to and in a direction farther away from the first clamp head, capable of holding a workpiece located between the first clamp head and second clamp head, and tiltable in the perpendicular direction; and a drive unit driving the first and second clamp heads.

According to another aspect of the present invention, a clamp device includes a first clamp head movable but restricted in movement in a perpendicular direction that is at right angles to a travel direction, and serving as a reference side; a second clamp head movable in a direction coming closer to and in a direction farther away from the first clamp head, capable of holding a workpiece located between the first clamp head and second clamp head, and slidable in the perpendicular direction; and a drive unit driving the first and second clamp heads.

The clamp device preferably includes a rotation suppressing mechanism for the first clamp head. Moreover, the clamp device may include a position adjusting mechanism that can adjust the position of the first clamp head in the travel direction (for example, the initial reference position or secular reference position).

The drive unit includes a first holding member holding the first clamp head, a second holding member holding the second clamp head, first and second power transmission mechanisms transmitting power to the first and second holding members, and a power feed unit disposed below the first and second power transmission mechanisms, capable of feeding power to the first and second power transmission mechanisms. The first and second power transmission mechanisms differ in structure.

The first power transmission mechanism may include a first power transmission member receiving a portion of the first holding member, and engaging with the first holding member in the travel direction of the first clamp head to transmit power to the first holding member. In this case, a gap is preferably provided between the first power transmission member and the first holding member. Furthermore, the power feed unit may include a movable member arranged in a casing. The second power transmission mechanism may include a second power transmission member provided rotatable in the casing, and linking one end of the movable member with the second holding member such that the movable member and the second holding member are movable in opposite directions. In this case, an engaging portion that engages with the first power transmission member may be provided at the other end side of the movable member.

A clamp method according to the present invention includes the steps set forth below. A workpiece is disposed so as to extend from a region between a first clamp head, serving as a reference side, restricted in movement in a perpendicular direction that is at right angles to a travel direction, and a second clamp head movable in a direction coming closer to and in a direction farther away from the first clamp head, and tiltable or slidable in the perpendicular direction, to a region between a third clamp head, serving as a reference side, restricted in movement in a perpendicular direction that is at right angles to the travel direction, and a fourth clamp head movable in a direction coming closer to and in a direction farther away from the third clamp head, and tiltable or slidable in said perpendicular direction. By moving the first and second clamps heads in a direction coming closer to each other, and moving the third and fourth clamp heads in a direction coming closer to each other, a workpiece can be clamped by the first, second, third and fourth clamp heads.

The step of clamping the workpiece preferably includes the step of clamping the workpiece by moving the second and fourth clamp heads towards the first and third clamp heads, respectively, while the second and fourth clamp heads are tilted or slid in the perpendicular direction in a state where position deviation of the workpiece is suppressed by the first and third clamp heads.

### Effects of the Invention

Since the clamp device of the present invention includes a first clamp head, serving as a reference side, restricted in movement in a perpendicular direction at right angles to a travel direction, the workpiece can be clamped at a prescribed position based on the first clamp head as a reference. Therefore, degradation in the accuracy of the workpiece holding position can be obviated. Further, by the provision of a second clamp head that is tiltable or slidable, the second clamp head can be tilted or slid in the operation of holding the workpiece to ensure an area of contact between at least the second clamp head and workpiece. Therefore, the workpiece can be clamped stably.

According to the clamp method of the present invention, degradation in the accuracy of the workpiece holding position can be obviated since the workpiece can be clamped at a prescribed position with the first and third clamp heads as the reference. Furthermore, since the second and fourth clamp heads can be tilted or slid in the operation of holding the workpiece, the area of contact between the workpiece and the clamp head can be ensured. Thus, the workpiece can be clamped stably.

### BRIEF DESCRIPTION OF THE DRAWINGS

FIG. 1 is a sectional view of a clamp device according to an embodiment of the present invention, corresponding to the state where the clamp head is moved back.

FIG. 2 is a sectional view of a clamp device according to an embodiment of the present invention, corresponding to a state where the clamp head is advanced.

FIG. 3 is a perspective view of a work support apparatus including a clamp device according to an embodiment of the present invention.

FIG. 4 is a plan view of a clamp device of the present invention, representing a modification.

FIG. 5 is a partial sectional view of the clamp device of FIG. 4.

FIG. 6 is a plan view of a clamp device of the present invention, representing another modification.

FIG. 7 is a partial sectional view of a clamp device of FIG. 6.

FIG. 8 is a sectional view of the clamp device of FIG. 1, corresponding to a modification.

### DESCRIPTION OF THE REFERENCE CHARACTERS

1, 1a, 1b clamp device; 2 casing; 3 bottom plate; 4, 40, 41 first clamp head; 4a, 5a claw; 4b, 5b plate; 5, 50, 51 second clamp head; 5b1, 5b3 15b, 53 recess; 52b, 5a1, 22a, 54 through hole; 6 workpiece; 7a, 7b, 8, 80 clamp rod; 8a, 18a hook portion; 8b curve; 8c, 15a teeth; 9a, 9b, 10 connection member; 10a head; 11, 16 steel ball; 12 pinion; 13 washer; 14 shim; 15 rack; 15a slide member; 17, 21, 25 guide member; 18 pipe member; 19a, 19b, 33a, 33b hydraulic oil feed port; 20 piston; 20a, 20b oil channel; 20c, 22b engaging portion; 22 power transmission plate; 23a, 23b oil chamber; 24a, 24b seal member; 26a, 26b fixture member; 30 work support apparatus; 31 base plate; 32 positioning unit

### BEST MODES FOR CARRYING OUT THE INVENTION

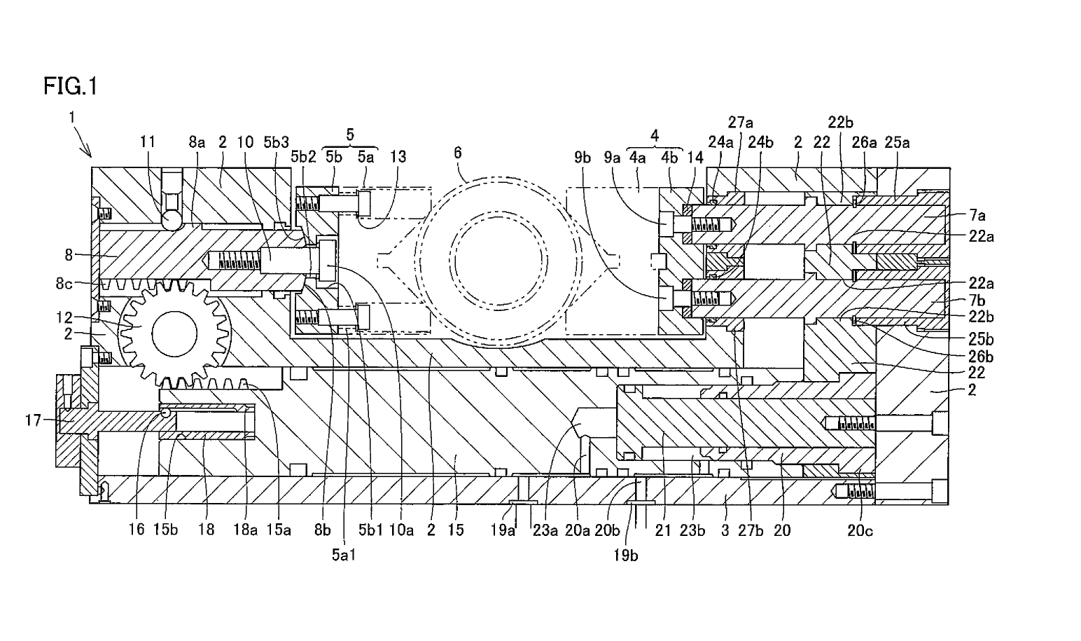

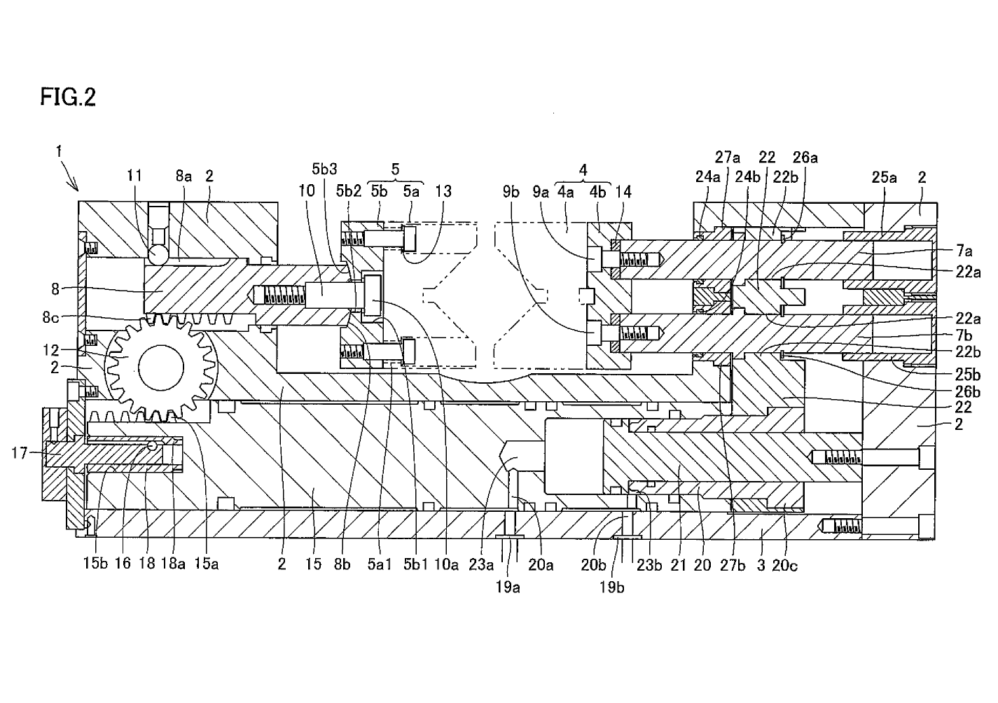

Embodiments of the present invention will be described hereinafter with reference to FIGS. 1-7. FIGS. 1 and 2 are sectional views of a clamp device 1 according to an embodiment of the present invention.

As shown in FIGS. 1 and 2, clamp device 1 includes a casing 2, first and second clamp heads 4 and 5 attached to opposite walls of casing 2 in a retractable manner, and a drive unit incorporated in casing 2 to drive first and second clamp heads 4 and 5. Each element of clamp device 1 can be formed mainly of a metal material or a material of equivalent property.

Casing 2 constitutes an outer shell of clamp device I to encase various elements of clamp device 1. First clamp head 4 serves as the reference side, and can move in a direction coming closer to and a direction father away from second clamp head 5 (in the horizontal direction in FIG. 1), but restricted in movement in a perpendicular direction that is at right angles to the travel direction. Specifically, although first clamp head 4 may move slightly corresponding to a general play in a direction perpendicular to the travel direction, first clamp head 4 is installed so as not to substantially move in the perpendicular direction.

First clamp head 4 includes a claw 4a and a plate 4b. The cross section of claw 4a corresponds to a recess of substantially a V shape. The surface of the concave side abuts against a workpiece 6. Plate 4b is arranged between claw 4a and clamp rods (first holding member) 7a and 7b for connection therebetween. In the examples of FIGS. 1 and 2, plate 4b is connected to clamp rods 7a and 7b via connection members 9a and 9b such as a bolt.

By the provision of first clamp head 4, serving as a reference side, restricted in movement in the perpendicular direction at right angles to the travel direction, workpiece 6 can be clamped at a prescribed position with first clamp head 4 as a reference. Thus, degradation in the accuracy of the holding position of workpiece 6 can be obviated.

Preferably, a position adjustment member that can adjust the position of first clamp head 4 in the travel direction is disposed between clamp rods 7a, 7b and first clamp head 4. In the examples of FIGS. 1 and 2, a single or plurality of shims are arranged as the position adjustment member between clamp rods 7a, 7b and plate 4b, Accordingly, the initial reference position and/or secular reference position of first clamp head 4 with respect to the travel direction can be adjusted.

Pipe guide members 27a and 27b are attached to one end of clamp rods 7a and 7b (the end at the side of first clamp head 4). Pipe guide members 25a and 25b are attached to the other end of clamp rods 7a and 7b (the end remote from first clamp head 4). By providing pipe guide members at either end of clamp rods 7a and 7b, clamp rods 7a and 7b can be driven stably.

Seal members 24a and 24b are arranged between guide members 27a and 27b and clamp rods 7a and 7b. Accordingly, intrusion of oil and debris, when workpiece 6 is machined, for example, into casing 2 or into the sliding region of clamp rods 7a and 7b, can be prevented.

Second clamp head 5 can hold workpiece 6 located between second clamp head 5 and first clamp head 4, and can travel in a direction coming closer to and in a direction farther away from first clamp head 4. Movement in the perpendicular direction at right angles to the travel direction is allowed. In the example of FIG. 1, second clamp head 5 is tiltable and slidable in the perpendicular direction at right angles to the travel direction of second clamp head 5. Second clamp head 5 may be configured to allow the operation of at least one of a tilting and sliding movement.

Second clamp head 5 includes a claw 5a and a plate 5b. Similarly, the cross section of claw 5a corresponds to a recess of substantially a V shape. The surface of the recess side abuts against workpiece 6. Plate 5b is disposed between claw 5a and clamp rod (second holding member) 8 for connection therebetween. In the examples of FIGS. 1 and 2, plate 5b is connected to clamp rod 8 via a connection member 10 such as a bolt.

By the provision of second clamp head 5 that can move in a perpendicular direction at right angles to the travel direction, second clamp head 5 can be tilted and/or slid in the perpendicular direction in the operation of clamping workpiece 6 to ensure an area of contact between second clamp head 5 and workpiece 6. Therefore, workpiece 6 can be clamped stably by first and second clamp heads 4 and 5.

As shown in FIGS. 1 and 2, plate 5b includes recesses 5b1 and 5b3, and a through hole 5b2, through which connection member 10 is inserted. Plate 5b is connected with clamp rod 8 via connection member 10. Specifically, in a state where a head 10a of connection member 10 is fitted in recess 5b 1 and the shaft portion of connection member 10 is passed across through hole 5b2, connection member 10 is screwed to clamp rod 8. Thus, plate 5b is connected with clamp rod 8 via connection member 10.

At this stage, the width of recess 5b1 (the width in the vertical direction in FIGS. 1 and 2) is set larger than the width of head 10a of connection member 10 (the width in the vertical direction in FIGS. 1 and 2), and the diameter of through hole 5b2 is set larger than the diameter of the shaft portion of connection member 10. Furthermore, the bottom face of recess 5b3 is formed in a curve that becomes greater in depth towards its center (preferably, a spherical surface), and the leading end face of clamp rod 8 is formed to have a convex curve 8b that becomes greater in height towards its center (preferably, a spherical surface). By such a configuration, second clamp head 5 is allowed to tilt or swing in a perpendicular direction (vertical direction in FIGS. 1 and 2) with respect to the travel direction of second clamp head 5.

Claw 5a of second clamp head 5 is connected to plate 5b via a connection member such as a bolt typically. In this case, a recess and a through hole 5a1 to receive the connection member are provided at claw 5a. The diameter of through hole 5a1 is set larger than the diameter of the connection member that is to be located in through hole 5a1. Accordingly, claw 5a of second clamp head 5 can be slid in a perpendicular direction (vertical direction in FIGS. 1 and 2) with respect to the travel direction of second clamp head 5. In addition, a flat resilient member 13 such as a washer is disposed between the head of the connection member and the bottom surface of the recess that receives the head of the connection member.

Clamp rod 8 includes a hook portion 8a. A stopper member 11 that can hold hook portion 8a under engagement is arranged in casing 2. In the examples of FIGS. 1 and 2, stopper member 11 is provided by forming a through hole in casing 2, and situating a sphere such as a steel ball above the through hole so as to protrude inwardly into the casing from the through hole. A support member that supports the sphere is disposed in the through hole.

The drive unit includes the aforementioned clamp rods 7a and 7b holding first clamp head 4, the aforementioned clamp rod 8 holding second clamp head 5, a first power transmission mechanism transmitting power to clamp rods 7a and 7b, a second power transmission mechanism transmitting power to clamp rod 8, and a power feed unit such as an actuator, arranged below first and second power transmission mechanisms, capable of supplying power to the first and second power transmission mechanisms.

In the examples of FIGS. 1 and 2, a plurality of clamp rods 7a and 7b in a columnar form are provided to suppress rotation of first clamp head 4. Specifically, the rotation of first clamp head 4 about the center axis of first clamp head 4 extending along the travel direction of first clamp head 4 is prevented. By virtue of clamp device 1 including such a rotation suppressing mechanism for first clamp head 4, the rotation of first clamp head 4 about the center axis can be prevented. This configuration is advantageous in that degradation in the accuracy of the clamping position of workpiece 6 can be suppressed effectively.

In the examples of FIGS. 1 and 2, rotation of first clamp head 4 is prevented by first clamp head 4 being supported via a plurality of clamp rods 7a and 7b. Other means for preventing rotation of first clamp head 4 may be provided. One possible means for preventing rotation of first clamp head 4 is to set the transverse cross section of the clamp rod to be not a circle (for example, an ellipse, a polygon, or the like). In this case, the number of clamp rods may be one.

The first power transmission mechanism includes a power transmission plate (power transmission member) 22 in the examples of FIGS. 1 and 2. Power transmission plate 22 includes a through hole 22a receiving a portion of clamp rods 7a and 7b, an engaging portion 22b engaging with clamp rods 7a and 7b in the travel direction (longitudinal direction) of clamp rods 7a and 7b to transmit power. Power transmission plate 22 is secured to clamp rods 7a and 7b via fixture members 26a and 26b.

A gap is preferably provided between power transmission plate 22 and clamp rods 7a, 7b. By setting the diameter of through hole 22a larger than the diameter of clamp rods 7a and 7b, a gap can be provided between power transmission plate 22 and clamp rods 7a, 7b. The provision of such a gap can prevent deformation in power transmission plate 22 from adversely affecting clamp rods 7a and 7b (for example, the clamping force may be lost and/or the positioning accuracy may be degraded as a result of a force being exerted to the clamp rod in the perpendicular direction caused by the deformation of the power transmission plate). Power can be transmitted effectively to clamp rods 7a and 7b via power transmission plate 22.

It is to be noted that a power transmission member other than the above-described power transmission plate 22 such as a block member or rod member can be employed, as long as power can be transmitted to clamp rods 7a and 7b.

The second power transmission mechanism includes a pinion 12 in the examples of FIGS. 1 and 2. In the present embodiment, the first and second power transmission mechanisms have different structures. Pinion 12 meshes with both a teeth portion (toothed structure) 8c, each tooth protruding from the surface of clamp rod 8, and a teeth portion (toothed structure) 15a, each tooth protruding from the surface at one end of rack 15 in the axial direction to transmit the power from rack 15 to clamp rod 8.

A recess 15b is provided at one end of rack 15 in the axial direction. A pipe member 18 is fitted in recess 15b. Pipe member 18 includes a threaded region at the outer circumferential face, a recess at the inner circumferential face, and a hook portion 18a at one end in the axial direction. A guide member 17 inserted in pipe member 18 is provided so as to protrude inwardly from casing 2. A steel ball 16 is provided between the inner circumferential face of pipe member 18 and guide member 17. One end of guide member 17 protrudes outwardly of casing 2, and a handle is connected to the end of guide member 17. By turning this handle, guide member 17 is rotated to cause rotation of pipe member 18 via steel ball 16 held immovable by guide member 17. Accordingly, pipe member 18 can be moved in the axial direction of rack 15. The clamp stroke can be adjusted by moving pipe member 18 in this manner.

The power feed unit includes a movable member arranged in casing 2, in the examples of FIGS. 1 and 2. This movable member includes rack 15 set forth above and a piston 20. Rack 15 and piston 20 are connected to each other to be unified. For example, rack 15 can be integrated with piston 20 by screwing together the ends of rack 15 and piston 20 in the axial direction.

Rack 15 is allowed to reciprocate in accordance with guide member 17, whereas piston 20 is allowed to reciprocate in accordance with guide member 21. Guide member 21 is attached to casing 2 by means of a connecting member such as a bolt.

Power transmission plate 22 set forth above is secured to rack 15 and piston 20. In the examples of FIGS. 1 and 2, an engaging portion 20c engaging with power transmission plate 22 in the travel direction of piston 20 is provided at one end of piston 20 in the axial direction to establish connection between engaging portion 20c and one end of rack 15 by sandwiching one end of power transmission plate 22 therebetween. Alternatively, other means may be employed to secure rack 15, piston 20, and power transmission plate 22 with each other. By fixing rack 15, piston 20, and power transmission plate 22 in an integral manner, they can be moved together.

In the examples of FIGS. 1 and 2, a cavity corresponding to the inner space in the cylinder is defined by bottom plate 3 constituting a portion of casing 2 and another portion of casing 2 in the proximity. The movable member including rack 15 and piston 20 are arranged to be movable in this cavity.

An oil chamber 23a into which oil can be introduced is formed between the larger-diameter portion of guide member 21 and rack 15. An air chamber 23b into which oil can be introduced is formed between the larger-diameter portion of guide member 21 and piston 20. Namely, the oil chamber defined between rack 15 and piston 20 is divided into two oil chambers by the larger-diameter portion of guide member 21.

Hydraulic oil feed ports 19a and 19b are provided at bottom plate 3 to allow oil to be fed into casing 2 from an external source via hydraulic oil feed ports 19a and 19b. Oil channels 20a and 20b communicating with hydraulic oil feed ports 19a and 19b are provided in casing 2. Since oil channels 20a and 20b are also communicating with oil chambers 23a and 23b, respectively, communication is established between hydraulic oil feed port 19a and oil chamber 23a and between hydraulic oil feed port 19b and oil chamber 23b via oil channels 20a and 20b, respectively. In the examples of FIGS. 1 and 2, a first channel passing through bottom plate 3, a second channel communicating with the first channel, and corresponding to the gap between rack 15 and bottom plate 3, and a third channel communicating with the second channel and passing through a portion of rack 15 constitute oil channels 20a and 20b. Although the movable member is driven by oil pressure in the examples of FIGS. 1 and 2, the movable member may be driven by means other than oil pressure.

An operation of clamp device 1 having a configuration set forth above will be described hereinafter.

First, an operation of transition from the state of FIG. 2 to the state of FIG. 1 by moving first and second clamp heads 4 and 5 back will be described.

In order to move back first and second clamp heads 4 and 5 from the state of FIG. 2, oil is supplied from an hydraulic oil feed source not shown (for example, hydraulic oil pump, hydraulic oil circuit, and the like) via hydraulic oil feed port 19b and oil channel 20b. Accordingly, the leading end of piston 20 is pushed by the pressure of oil supplied in oil chamber 23b, whereby piston 20 moves rightward in FIG. 2. At this stage, the volume in oil chamber 23 a is reduced such that oil therein flows outside via oil channel 20a and hydraulic oil feed port 19a.

The rightward travel of piston 20 causes rack 15 and power transmission plate 22 integrated with piston 20 to move in the same direction together with piston 20. Accordingly, clamp rods 7a and 7b engaging with power transmission plate 22 travel rightwards, which in turn causes first clamp head 4 to travel rightwards. As a result, first clamp head 4 can be moved back from the state of FIG. 2.

Further, the travel of rack 15 together with piston 20 causes rotation of pinion 12 that meshes with rack 15, whereby clamp rod 8 with teeth portion 8c meshing with pinion 12 is moved. It is to be noted that clamp rod 8 moves in a direction opposite to that of piston 20 and rack 15. As a result, second clamp head 5 can be moved leftwards in FIG. 2, allowing second clamp head 5 to move back from the state of FIG. 2.

By moving first and second clamp heads 4 and 5 both back as set forth above, transition from the state of FIG. 2 to the state of FIG. 1 is established. During this transition, the clamped state of workpiece 6 by first and second clamp heads 4 and 5 can be released.

Next, the operation of transition from the first state of FIG. 1 to the second state of FIG. 2 by moving first and second clamp heads 4 and 5 forward will be described.

In order to move first and second clamp heads 4 and 5 forward from the state of FIG. 1, oil is fed into oil chamber 23a from an hydraulic oil feed source not shown via hydraulic oil feed port 19a and oil channel 20a. Accordingly, rack 15 is pushed by the pressure of oil supplied in oil chamber 23a to cause rack 15 to travel leftwards in FIG. 1. At this stage, the volume of oil chamber 23b is reduced. Accordingly, the oil in oil chamber 23b flows outside via oil channel 20b and hydraulic oil feed port 19b.

The travel of rack 15 leftwards causes piston 20 and power transmission plate 22 integral with rack 15 to move in the same direction with rack 15. In response, clamp rods 7a and 7b engaging with power transmission plate 22 move leftwards, which in turn causes first clamp head 4 to travel leftwards. Namely, first clamp head 4 can be advanced from the state of FIG. 1.

The travel of rack 15 also causes rotation of pinion 12 that meshes with rack 15, whereby clamp rod 8 having teeth portion 8c that meshes with pinion 12 moves. Since clamp rod 8 travels in a direction opposite to that of piston 20 and rack 15, second clamp head 5 moves rightward in FIG. 1. As a result, second clamp head 5 can be moved forward from the state of FIG. 1.

Thus, first and second clamp heads 4 and 5 can both be moved forward to allow transition from the state of FIG. 1 to the state of FIG. 2 set forth above. During this transition, workpiece 6 can be clamped by first and second clamp heads 4 and 5. Workpiece 6 can be subjected to machining such as cutting in a clamped state.

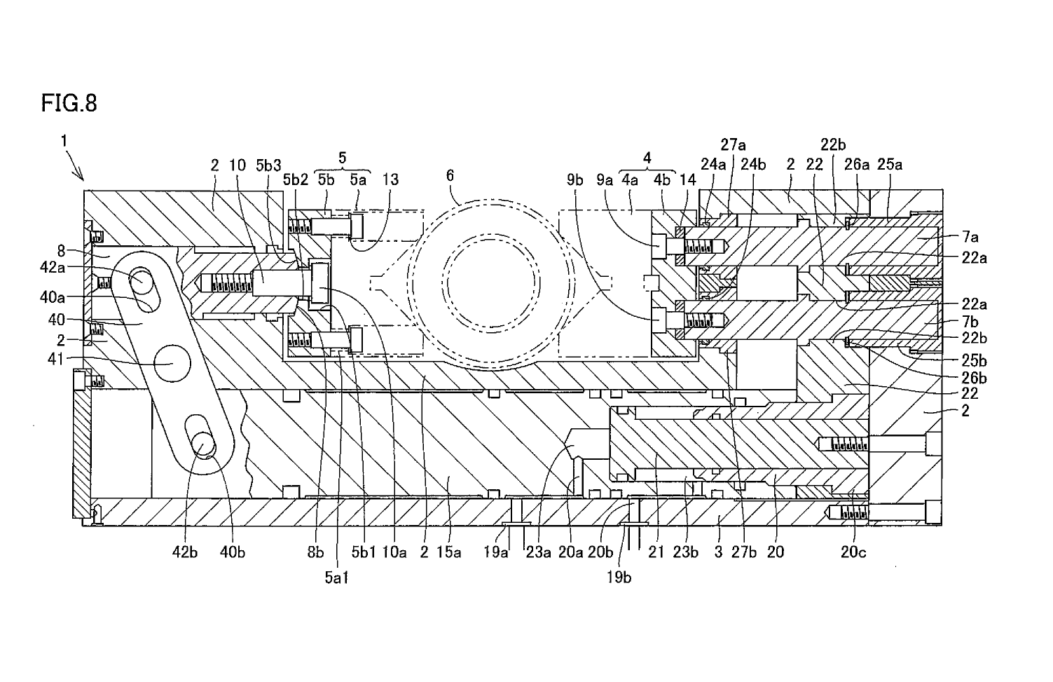

A modification of clamp device 1 set forth above will be described hereinafter with reference to FIG. 8. As compared to clamp device 1 shown in FIG. 1 having the power from rack 15 transmitted to clamp rod 8 via pinion 12, slide member 15a can be linked with clamp rod 8 by a plate-like link member 40 to transmit the power from slide member 15a to clamp rod 8 via link member 40.

As shown in FIG. 8, a shaft (rotational shaft) 41 is installed at casing 2. A rotatable link member 40 is attached to shaft 41. Elongated holes 40a and 40b are formed at both ends of link member 40. A pin 42a is provided at clamp rod 8. A pin 42b is provided at slide member 15a. Pin 42a is located in elongated hole 40a, whereas pin 42b is located in elongated hole 40b. The remaining structure is basically similar to that described above.

The present modification similarly allows slide member 15a to travel in the desired direction by appropriately feeding oil into oil chambers 23a and 23b. At the same time, clamp rod 8 can be moved in a direction opposite to that of slide member 15a.

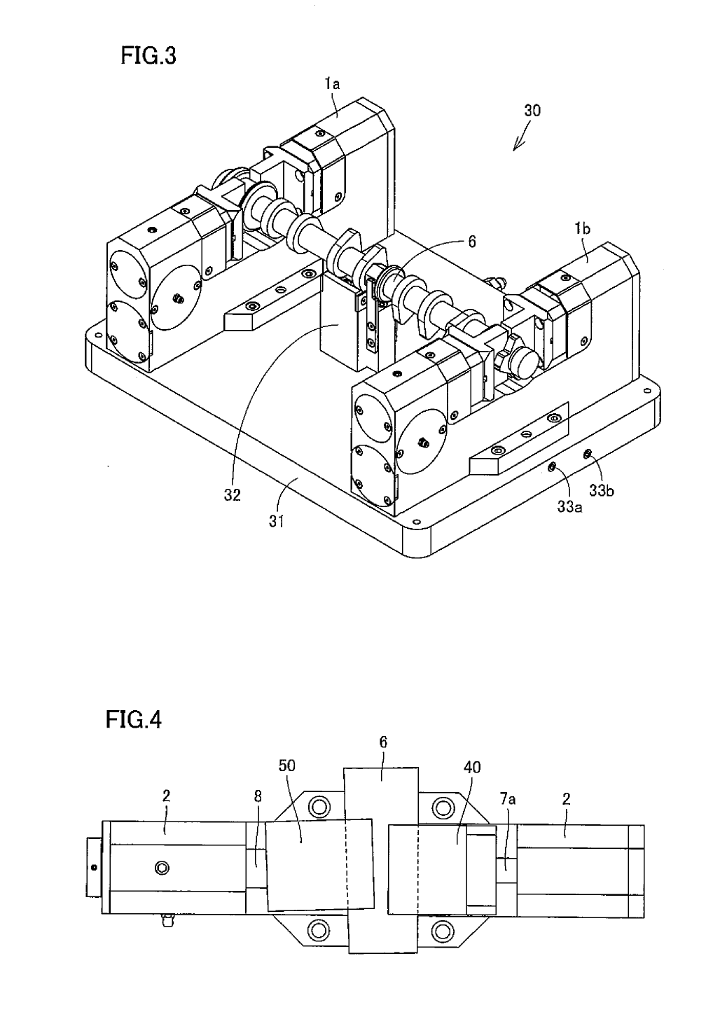

An application of clamp device 1 set forth above will be described hereinafter with reference to FIG. 3.

As shown in FIG. 3, clamp device 1 set forth above is applicable to a work support apparatus 30 that applies a process such as cutting under a state where a workpiece 6 such as a camshaft or crankshaft is held.

Work support apparatus 30 includes, as shown in FIG. 3, a base plate 31, clamp devices 1a and 1b spaced apart on base plate 31, and a positioning unit 32 that can position workpiece 6 in the longitudinal direction. Hydraulic oil feed ports 33a and 33b are provided at base plate 31 to allow introduction of the hydraulic oil. The configuration of clamp devices 1a and 1b is basically similar to that of clamp device 1 set forth above.

A method of clamping an elongated workpiece 6 using work support apparatus 30 will be described hereinafter.

Each of clamp devices 1a and 1b of FIG. 3 includes first and second clamp heads 4 and 5 having a configuration set forth above. As shown in FIG. 3, workpiece 6 of an elongated shape is disposed to extend from a region between first and second clamp heads 4 and 5 of clamp device 1a to a region between first and second clamp heads 4 and 5 of clamp device 1b.

First clamp heads 4 of clamp devices 1a and 1b are located at the same side with respect to workpiece 6. Second clamp heads 5 of clamp devices 1a and 1b are located at the same side with respect to workpiece 6. As set forth above, first clamp head 4 is restricted in movement in a perpendicular direction that is at right angles to the travel direction of first head 4, serving as the reference side, whereas second clamp head 5 is movable in a direction coming closer to and in a direction farther away from first clamp head 4, and tiltable or slidable in the perpendicular direction.

By moving first and second clamp heads 4 and 5 of clamp device 1a in a direction coming closer to each other and also moving first and second clamp heads 4 and 5 of clamp device 1b in a direction coming closer to each other, workpiece 6 is clamped by these four clamp heads.

At this stage, workpiece 6 can be clamped at a prescribed position by suppressing position deviation of workpiece 6 by means of first clamp heads 4 of clamp devices 1a and 1b and moving second clamp heads 5 of clamp devices 1a and 1b towards first clamp heads 4 in a tilting or sliding manner in the perpendicular direction.

Since workpiece 6 can be clamped at a prescribed position with one set of first clamp heads 4 as the reference in accordance with the clamp method set forth above, degradation in accuracy of the clamping position of workpiece 6 can be obviated. Further, since one set of second clamp heads 5 can be tilted or slid in the operation of clamping workpiece 6, the area of contact between workpiece 6 and each clamp head can be ensured to allow workpiece 6 to be clamped stably. The aforementioned machining process such as cutting can be carried out with workpiece 6 held in a prescribed position.

A modification of the embodiment set forth above will be described hereinafter with reference to FIGS. 4-7.

The above-described embodiment is based on an example in which second clamp head 5 is tiltable and slidable. A second clamp head that is capable of either tilting or sliding and an example of a structure in the neighborhood will be described hereinafter.

As shown in FIGS. 4 and 5, a second clamp head 50 can be set to allow substantially only a tilting movement in a direction perpendicular to the travel direction. Specifically, second clamp head 50 is formed of a unitary member. The leading end face of clamp rod 8 is formed to have a convex curve (preferably, a spherical surface) 8b that becomes greater in height towards its center, and the bottom face of the recess of second clamp head 50 in which the leading end of clamp rod 8 is received is formed in a curve (preferably, a spherical surface) that becomes greater in depth towards its center.

By providing a curve 8b and the like as set forth above, second clamp head 5 is allowed to tilt in a direction perpendicular to the travel direction. However, a sliding movement in the direction perpendicular to the travel direction is substantially disallowed since through hole Sal shown in FIG. 1 and the like is not provided.

Head 10a of connection member 10 is arranged in recess 53. The shaft portion of connection member 10 is passed across through hole 54 to reach clamp rod 8. The structure on the part of first clamp head 40 is similar to that of the above-described embodiment. First clamp head 40 includes a claw 40a and a plate 40b.

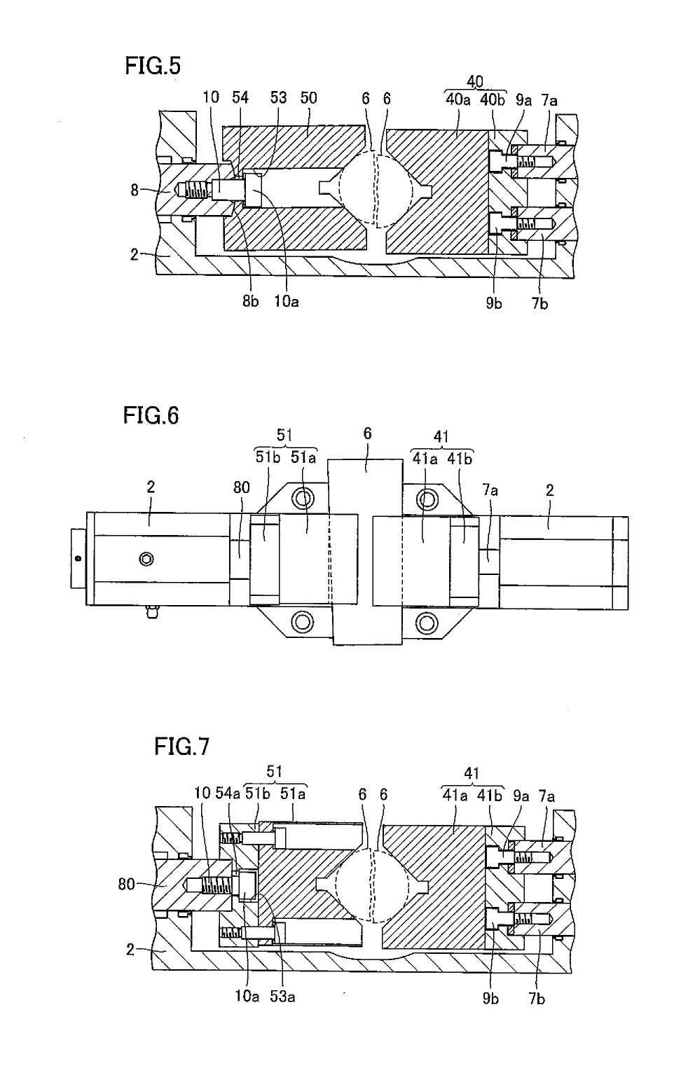

As shown in FIGS. 6 and 7, a second clamp head 51 can be set to allow substantially only a sliding movement in a direction perpendicular to the travel direction. Specifically, the leading end face of clamp rod 80 is set flat. Second clamp head 51 is divided into a claw 51a and a plate 51b. Claw 51a is connected to plate 51b via a connection member such as a bolt. A recess and a through hole to receive the connection member are provided at claw 51a. The diameter of the through hole is set larger than the diameter of the connection member located in the through hole.

By increasing the diameter of the through hole that receives the connection member establishing connection between claw 51a and plate 51b, second clamp head 5 can be slid in a direction perpendicular to the travel direction. However, a tilting movement of second clamp head 5 in the direction perpendicular to the travel direction is substantially disallowed since curve 8b and the like shown in FIG. 1 is not provided.

Head 10a of connection member 10 is arranged in recess 53a. The shaft portion of connection member 10 is passed across through hole 54a to reach clamp rod 80. In the present modification, the structure on the part of first clamp head 41 is similar to that of the above-described embodiment. First clamp head 41 includes a claw 41a and a plate 41b.

According to the description of the embodiments of the present invention set forth above, it is expected that the configuration of each of the above-described embodiments may be combined appropriately. Furthermore, each structural element in the above-described embodiments is not all necessarily mandatory, and some of the structural elements are intended to be omitted. It will be understood that the embodiments disclosed herein are by way of example only, and is not to be taken by way of limitation in all aspects. The scope of the present invention is defined by the appended claims, and all changes that fall within limits and bounds of the claims, or equivalents thereof are intended to be embraced by the claims.

### INDUSTRIAL APPLICABILITY

The present invention is effectively used for a clamp device that can clamp a workpiece from both sides.

1. A clamp device comprising:
a first clamp head movable but restricted in movement in a perpendicular direction that is at right angles to a travel direction, and serving as a reference side,
a second clamp head movable in a direction coming closer to and in a direction farther away from said first clamp head, capable of clamping a workpiece that is located between said first and second clamp heads, and tillable in said perpendicular direction, and
a drive unit driving said first and second clamp heads.

2. The clamp device according to claim 1, further comprising a rotation suppressing mechanism for said first clamp head.

3. The clamp device according to claim 1, further comprising a position adjusting mechanism that can adjust a position of said first clamp head in the travel direction.

4. The clamp device according to claim 1, wherein said drive unit comprises a first holding member holding said first clamp head, a second holding member holding said second clamp head, first and second power transmission mechanisms transmitting power to said first and second holding members, and a power feed unit disposed below said first and second power transmission mechanisms, capable of feeding power to said first and second power transmission mechanisms,
said first and second power transmission mechanisms differ in structure.

5. The clamp device according to claim 4, wherein
said first power transmission mechanism includes a first power transmission member receiving a portion of said first holding member, and engaged with said first holding member in the travel direction of said first clamp head to transmit power to said first holding member,
a gap is provided between said first power transmission member and said first holding member,
said power feed unit includes a movable member disposed in a casing,
said second power transmission mechanism includes a second power transmission member provided rotatable in said casing, linking one end of said movable member with said second holding member such that said movable member and said second holding member are movable in opposite directions,
an engaging portion engaging with said first power transmission member is provided at an other end side of said movable member.

6. A clamp device comprising:
a first clamp head movable but restricted in movement in a perpendicular direction that is at right angles to a travel direction, and serving as a reference side,
a second clamp head movable in a direction coming closer to and in a direction farther away from said first clamp head, capable of clamping a workpiece that is located between said first and second clamp heads, and slidable in said perpendicular direction, and
a drive unit driving said first and second clamp heads.

7. The clamp device according to claim 6, further comprising a rotation suppressing mechanism for said first clamp head.

8. The clamp device according to claim 6, further comprising a position adjusting mechanism that can adjust a position of said first clamp head in the travel direction.

9. The clamp device according to claim 6, wherein said drive unit comprises a first holding member holding said first clamp head, a second holding member holding said second clamp head, first and second power transmission mechanisms transmitting power to said first and second holding members, and a power feed unit disposed below said first and second power transmission mechanisms, capable of feeding power to said first and second power transmission mechanisms,
said first and second power transmission mechanisms differ in structure.

10. The clamp device according to claim 9, wherein
said first power transmission mechanism includes a first power transmission member receiving a portion of said first holding member, and engaged with said first holding member in the travel direction of said first clamp head to transmit power to said first holding member,
a gap is provided between said first power transmission member and said first holding member,
said power feed unit includes a movable member disposed in a casing,
said second power transmission mechanism includes a second power transmission member provided rotatable in said casing, linking one end of said movable member with said second holding member such that said movable member and said second holding member are movable in opposite directions,
an engaging portion engaging with said first power transmission member is provided at an other end side of said movable member.

11. A clamp method comprising the steps of:
disposing a workpiece so as to extend from a region between a first clamp head, serving as a reference side, restricted in movement in a perpendicular direction that is at right angles to a travel direction, and a second clamp head movable in a direction coming closer to and in a direction farther away from said first clamp head, and tiltable or slidable in said perpendicular direction, to a region between a third clamp head, serving as a reference side, restricted in movement in the perpendicular direction that is at right angles to the travel direction, and a fourth clamp head movable in a direction coming closer to and in a direction farther away from said third clamp head, tiltable or slidable in said perpendicular direction, and
clamping said workpiece with said first, second, third and fourth clamp heads by moving said first and second clamp heads in a direction coming closer to each other, and moving said third and fourth clamp heads in a direction coming closer to each other.

12. The clamp method according to claim 11, wherein said step of clamping said workpiece includes the step of clamping said workpiece by moving said second and fourth clamp heads towards said first and third clamp heads, respectively, while said second and fourth clamp heads are tilted or slid in said perpendicular direction in a state where position deviation of said workpiece is suppressed by said first and third clamp heads.
